(19) United States
(12) Patent Application Publication
(10) Pub. No.: US 2025/0362702 A1
(43) Pub. Date: Nov. 27, 2025

(54) BANDGAP CIRCUIT

(71) Applicant: Winbond Electronics Corp., Taichung City (TW)

(72) Inventor: Kai-Hsu Cheng, New Taipei City (TW)

(73) Assignee: Winbond Electronics Corp., Taichung City (TW)

(21) Appl. No.: 18/945,576

(22) Filed: Nov. 13, 2024

(30) Foreign Application Priority Data
May 23, 2024 (TW) 113119112

(51) Int. Cl. G05F 3/26

(52) U.S. Cl. CPC G05F 3/262

(57) ABSTRACT

A bandgap circuit includes a current mirror circuit, a compensation circuit, and a startup circuit. The current mirror circuit includes a first transistor pair with control terminals coupled to each other at a first node. The first transistor pair is configured to generate a first voltage with a negative temperature coefficient at the first node. The compensation circuit is used to generate a second voltage with a positive temperature coefficient to the first node. The startup circuit is used to provide the first voltage to the first node when the bandgap circuit is initiated.

### CROSS-REFERENCE TO RELATED APPLICATION

This application claims the priority benefit of Taiwan application serial no. 113119112, filed on May 23, 2024. The entirety of the above-mentioned patent application is hereby incorporated by reference herein and made a part of this specification.

### BACKGROUND

### Technical Field

The disclosure relates to a circuit, and in particular to a bandgap circuit.

### Description of Related Art

In electronic devices, operating circuits are often affected by temperature changes.

Therefore, bandgap circuits are often used in the electronic devices to provide a stable reference voltage that is not affected by temperature.

### SUMMARY

The disclosure provides a bandgap circuit, which can provide a stable reference voltage that is not affected by temperature.

A bandgap circuit of the disclosure includes a current mirror circuit, a compensation circuit, and a startup circuit. The current mirror circuit has a first transistor pair with control terminals coupled to each other at a first node. The first transistor pair is configured to generate a first voltage with a negative temperature coefficient at the first node. The compensation circuit is used to generate a second voltage difference with a positive temperature coefficient to the first node. The startup circuit is used to provide the first voltage to the first node when the bandgap circuit is initiated.

A bandgap circuit of the disclosure includes a current mirror circuit, a compensation circuit, and a startup circuit. The current mirror circuit has a diode pair. The diode pair is configured to generate a first voltage with a negative temperature coefficient at a first node. The compensation circuit is used to generate a second voltage difference with a positive temperature coefficient to the first node. The startup circuit is used to provide the first voltage to the first node when the bandgap circuit is initiated.

A bandgap circuit of the disclosure includes a Widlar current mirror circuit, a compensation circuit, and a startup circuit. The Widlar current mirror circuit is configured to generate a first voltage with a positive temperature coefficient, and the Widlar current mirror circuit generates a second voltage difference with a negative temperature coefficient by a first node coupled between a first resistor and a first transistor. The compensation circuit is used to generate a first current according to the first voltage. When the startup circuit is used to initiate the bandgap circuit, the first voltage is provided to the compensation circuit to initiate the compensation circuit.

Based on the above, the disclosure provides the bandgap circuit, which can be quickly initiated, while providing a stable reference voltage that is not affected by temperature.

### BRIEF DESCRIPTION OF THE DRAWINGS

FIG. 1 to FIG. 14 are circuit block diagrams of a bandgap circuit in some embodiments.

### DESCRIPTION OF THE EMBODIMENTS

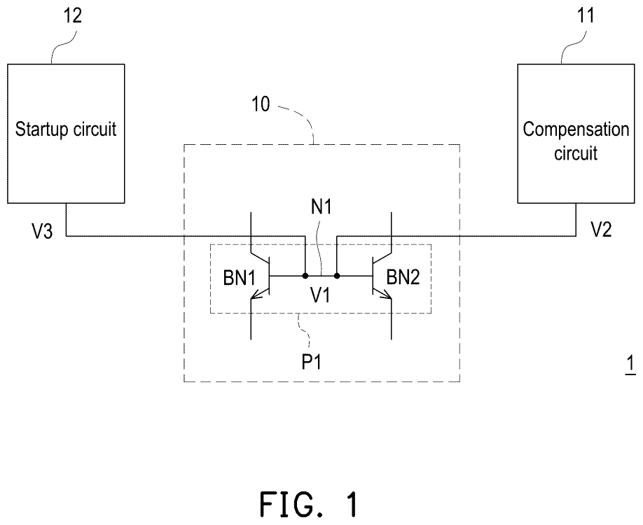

FIG. 1 is a circuit block diagram of a bandgap circuit 1. The bandgap circuit 1 may be used to generate a stable output voltage to eliminate non-ideal effects on the output voltage under different usage environments, thereby providing a stable power supply environment for other circuits in an electronic device. The bandgap circuit 1 includes a current mirror circuit 10, a compensation circuit 11, and a startup circuit 12. The current mirror circuit 10 has a first transistor pair P1 with control terminals coupled to each other at a first node N1. The first transistor pair P1 is configured to generate a first voltage V1 with a negative temperature coefficient at the first node N1. The compensation circuit 11 is used to generate a second voltage V2 with a positive temperature coefficient, and provide the second voltage V2 to the first node N1. When the startup circuit 12 is used to initiate the bandgap circuit 1, a third voltage V3 is provided to the first node N1 to provide the first voltage V1 to the first node N1.

During the operating process, internal circuit characteristics of the current mirror circuit 10 of the bandgap circuit 1 shift with temperature. Specifically, the first voltage V1 on the control terminal of the first transistor pair P1 in the current mirror circuit 10 of the bandgap circuit 1 has an incrementing or decrementing monotonous change as the temperature changes, the first voltage V1 generated by the first transistor pair P1 is the first voltage V1 with the negative temperature coefficient, which decrements as the temperature increases. On the contrary, the compensation circuit 11 may generate a second voltage difference ΔV2, which carries complementary or opposite temperature change information to the first voltage V1, in response to the temperature change. The second voltage difference ΔV2 may be a positive temperature coefficient. In order to compensate the drift of the current mirror circuit 10 in response to the temperature change, the compensation circuit 11 may provide the second voltage difference ΔV2 to the first node N1 of the current mirror circuit 10. At this time, the superposition of the first voltage V1 and the second voltage difference ΔV2 is reflected at the first node N1. Since the first voltage V1 and the second voltage difference ΔV2 have complementary temperature change information, when the temperature increases, the decrease of the first voltage V1 is approximately equal to the increase of the second voltage difference ΔV2, causing the superposition result of the first voltage V1 and the second voltage difference ΔV2 to remain approximately constant. In this way, affected by the stable voltage at the control terminal, a bias voltage or a bias current generated by the first transistor pair P1 in the current mirror circuit 10 may remain stable and is not affected by the temperature change, thus implementing the voltage stabilization function of the bandgap circuit 1.

During the startup process of the bandgap circuit 1, the bandgap circuit 1 is often affected by a charge/discharge rate. It takes a certain period of time for a specific node to be charged to an appropriate voltage level for the current mirror circuit 10 to enter the working state. In order to help the current mirror circuit 10 reach the working state more quickly, the startup circuit 12 may be used to quickly pull the control terminal of the first transistor pair P1 to an appropriate working voltage level when the bandgap circuit 1 is initiated. The startup circuit 12 is coupled to the first node N1 in the first transistor pair P1. The startup circuit 12 may provide the third voltage V3 with the first voltage to the first node N1 when the bandgap circuit 1 is initiated. The first voltage may be, for example, the working voltage of the first transistor pair P1. The startup circuit P1 may pull the first node N1 to the voltage level of the first voltage when the bandgap circuit 1 is initiated, so that the control terminal of the first transistor pair P1 may be quickly pulled to the working voltage when initiated, prompting the bandgap circuit 1 to enter the working state early, thereby shortening the startup waiting time required by the bandgap circuit 1.

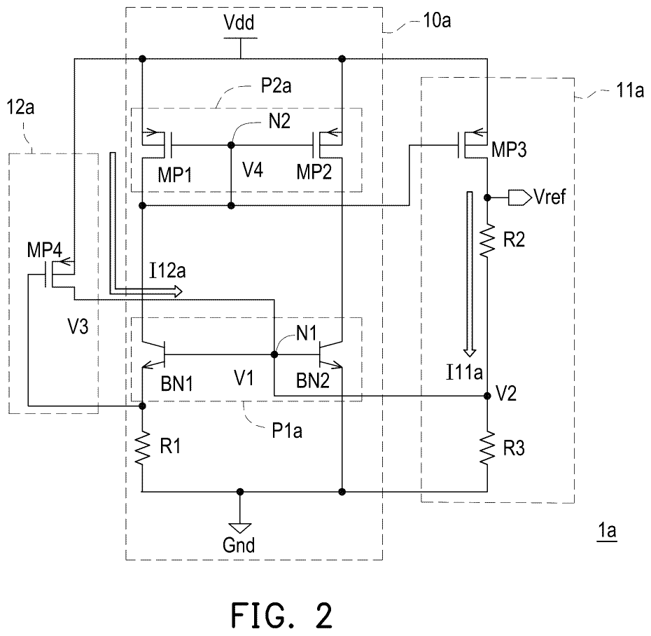

FIG. 2 is a circuit schematic diagram of a bandgap circuit 1a. The bandgap circuit 1a includes a current mirror circuit 10a, a compensation circuit 11a, and a startup circuit 12a. The current mirror circuit 10a has a first transistor pair P1a with control terminals coupled to each other at a first node N1. The first transistor pair P1a is configured to generate a first voltage V1 with a negative temperature coefficient at the first node N1. The compensation circuit 11a is used to generate a second voltage difference ΔV2 with a positive temperature coefficient, and provide the second voltage difference ΔV2 to the first node N1. When the startup circuit 12a is used to initiate the bandgap circuit 1a, a third voltage V3 is provided to the first node N1 to provide a first voltage (for example, a working voltage Vdd) to the first node N1.

The current mirror circuit 10a is, for example, a current mirror circuit with a Widlar current source. The current mirror circuit 10a includes a first transistor pair P1a, a second transistor pair P2a, and a resistor R1. The first transistor pair P1a includes transistors BN1 and BN2 with control terminals coupled to each other at the first node N1. The second transistor pair P2a includes transistors MP1 and MP2 with control terminals coupled to each other at a second node N2. The second transistor pair P2a is configured to receive a current provided by the first transistor pair P1a, and generate a fourth voltage V4 with a positive temperature coefficient at the second node N2.

The second transistor pair P2a includes the first transistor MP1 and the second transistor MP2. The first transistor MP1 has a first terminal receiving the first voltage, a second terminal coupled to the second node N2, and a control terminal coupled to the second node N2. The second transistor MP2 has a first terminal receiving the first voltage, a control terminal coupled to the second node N2, and a second terminal. The first transistor pair P1a includes the third transistor BN1 and the fourth transistor BN2. The third transistor BN1 has a first terminal coupled to the second terminal of the first transistor MP1, a second terminal coupled to the resistor R1, and a control terminal coupled to the first node N1, wherein the resistor R1 is coupled between the third transistor BN1 and a second voltage. The fourth transistor BN2 has a first terminal coupled to the second terminal of the second transistor MP2, a second terminal receiving the second voltage, and a control terminal coupled to the first node N1.

The compensation circuit 11a is coupled to the second transistor pair P2a at the second node N2. The compensation circuit 11a is configured via a current mirror to generate the second voltage difference ΔV2 according to the fourth voltage V4, and provide the second voltage difference ΔV2 to the first node N1. The compensation circuit 11a includes a fifth transistor MP3 and resistors R2 and R3. The fifth transistor MP3 has a first terminal receiving the first voltage, a control terminal coupled to the second node N2, and a second terminal. The resistor R2 has a first terminal coupled to the second terminal of the fifth transistor MP3 and a second terminal coupled to the first node N1. The resistor R3 has a first terminal coupled to the first node N1 and a second terminal receiving the second voltage.

The startup circuit 12a is used to provide the third voltage V3 to the first node N1 when the bandgap circuit 1a is initiated, so as to provide the first voltage to the first node N1. The startup circuit 12a includes a sixth transistor MP4. The sixth transistor MP4 has a first terminal receiving the first voltage, a second terminal coupled to the first node N1, and a control terminal coupled to the second terminal of the third transistor BN1.

The first transistor pair P1a and the second transistor pair P2a have opposite conduction types. The first transistor MP1 and the second transistor MP2 of the second transistor pair P2a are p-type metal oxide semi-transistors and have a first conduction type (for example, a low voltage conduction type). The third transistor BN1 and the fourth transistor BN2 of the first transistor pair Pla are n-type bipolar junction transistor (BJT) and have a second conduction type (for example, a high voltage conduction type). An aspect ratio of the first transistor MP1 to the second transistor MP2 to the fifth transistor MP3 is 1:1:N, where N is a positive real number. On the other hand, an emitter area ratio of the third transistor BN1 to the fourth transistor BN2 is M:1.

Generally speaking, the relationship between a base-emitter voltage difference V_{BE} of the bipolar junction transistor and the ambient temperature may be expressed as follows.

$${V}_{BE} = {V}_{T} ln ( \frac{{I}_{E}}{{I}_{S}} )$$

where V_{T} is a thermal voltage of the bipolar junction transistor, m≈−3/2, E_{g}≈1.12 eV, I_{E} is an emitter current flowing through the bipolar junction transistor, and I_{S} is a reverse saturation current. As shown in the above expression, the base-emitter voltage difference V_{BE} of the bipolar junction transistor is negatively correlated with temperature (that is, the base-emitter voltage difference V_{BE} of the bipolar junction transistor has a negative temperature coefficient) and decreases as the temperature increases. On the other hand, the emitter current I_{E} flowing through the bipolar junction transistor is positively correlated with temperature (that is, the emitter current I_{E} of the bipolar junction transistor has a positive temperature coefficient) and increases as the temperature increases.

Next, observing the first transistor pair P1a in FIG. 2, the first voltage V1 at the first node N1 may be expressed as follows.

$$V 1 = {V}_{BE 2} = {V}_{BE 1} + {V}_{R 1}$$

where V_{BE2} is a base-emitter voltage difference of the fourth transistor BN2, V_{BE1} is a base-emitter voltage difference of the third transistor BN1, and V_{R1} is a cross voltage on the resistor R1. Furthermore, a relational expression of the cross voltage on the resistor R1 may be obtained through the following derivation process.

$${V}_{R 1} = {V}_{B E 2} - {V}_{BE 1}$$

$${V}_{R 1} = {V}_{T} ln ( \frac{{I}_{E 2}}{{I}_{S}} ) - {V}_{T} ln ( \frac{{I}_{E 1}}{M \times {I}_{S}} )$$

$${V}_{R 1} = {V}_{T} \times ln ( \frac{{I}_{E 2}}{{I}_{E 2}} \times M )$$

where M is an emitter area ratio of the third transistor BN1 relative to the fourth transistor BN2. From the above expression, it can be seen that the cross voltage V_{R1} on the resistor R1 is not related to the reverse saturation current I_{S} and is only related to the thermal voltage VT and the natural logarithm of the multiplication result of a ratio of emitter currents flowing through the third transistor BN1 and the fourth transistor BN2 and an emitter area ratio of the third transistor BN1 relative to the fourth transistor BN2. Therefore, a relational expression of a reference voltage Vref generated by the bandgap circuit 1a may be obtained through the following derivation process.

$$\begin{matrix}{V}_{ref} = {I}_{R 3} \times R 3 + {I}_{R 2} \times R 2 \\ = {V}_{B E 2} + {I}_{M 3} \times R 2 \\ = {V}_{B E 2} + N \times {I}_{M 1} \times R 2 \\ = {V}_{B E 2} + N \times {I}_{E 1} \times R 2 \\ = {V}_{B E 2} + N \times \frac{{V}_{R 1}}{R 1} \times R 2\end{matrix}$$

The current mirror circuit 10a in the bandgap circuit 1a has a temperature-dependent relationship. In order to perform temperature compensation on the current mirror circuit 10a, the compensation circuit 11a is used to provide the second voltage V2 to offset changes in the temperature-dependent relationship in the current mirror circuit 10a. Specifically, the compensation circuit 11a is directly coupled to the second node N2 coupled to the control terminal in the second transistor pair P2a to generate the current I11a according to the fourth voltage V4 with the positive temperature coefficient at the second node N2. The current I11a may generate the output reference voltage Vref through the resistors R2 and R3. Moreover, the output reference voltage Vref may be divided through the resistance values of the resistors R2 and R3, and the divided second voltage difference ΔV2 is fed back to the first node N1 coupled to the control terminal of the first transistor pair P1a. In this way, by appropriately adjusting the magnitudes of the fifth transistor MP3 and the resistors R2 and R3, the temperature changes of the second voltage difference ΔV2 and the first voltage V1 are complementary. In this way, the voltages with negative temperature coefficients of the control terminals of the third transistor BN1 and the fourth transistor BN2 may be compensated by the second voltage difference ΔV2, so that the second voltage difference ΔV2 is unaffected by temperature changes. In this way, the bandgap circuit 1a can also output the reference voltage Vref that is stable and independent of temperature changes.

When the bandgap circuit 1a is initiated, it usually takes a long startup time for the voltage at each node in the circuit to gradually reach the stable working state. In this regard, the startup circuit 12a may provide the first voltage to the first node N1 when the bandgap circuit 1a is initiated. Specifically, when the bandgap circuit 1a is initiated, the first node N1 coupled to the control terminal of the first transistor pair P1a and the second node N2 coupled to the control terminal of the second transistor pair P2a are often floating and the potential is not clearly defined. Therefore, the sixth transistor MP4 of the startup circuit 12a may provide the first voltage to the first node N1, so that the first node N1 coupled to the control terminal of the first transistor pair Pla is defined when initiated, so that the transistor in the bandgap circuit 1a may quickly enter an appropriate working interval, shortening the startup time of the overall bandgap circuit 1a.

On the other hand, the voltage received by the control terminal of the startup circuit 12a is negatively correlated with temperature, so a current I12a provided by the startup circuit 12a to the first node N1 during the working process of the bandgap circuit 1a may have a negative correlation with temperature, the current I12a provided by the startup circuit 12a may serve a fine-tuning function for the compensation of the compensation circuit 11a, so that the operation of the bandgap circuit 1a is more stable.

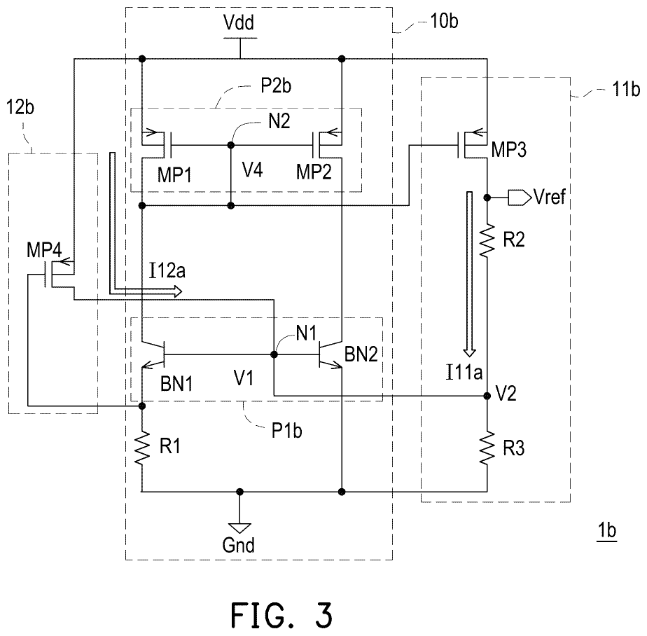

FIG. 3 is a circuit schematic diagram of a bandgap circuit 1b. The bandgap circuit 1b of FIG. 3 is similar to the bandgap circuit 1a of FIG. 2. The difference between the two is that in the bandgap circuit 1b of FIG. 3, an emitter area ratio of a third transistor BN1 to a fourth transistor BN2 of a first transistor pair P1b is M:1. An aspect ratio of a first transistor MP1 to a second transistor MP2 to a fifth transistor MP3 is still 1:1:N, where N is a positive real number. However, an emitter area ratio of the third transistor BN1 to the fourth transistor BN2 is 1:1.

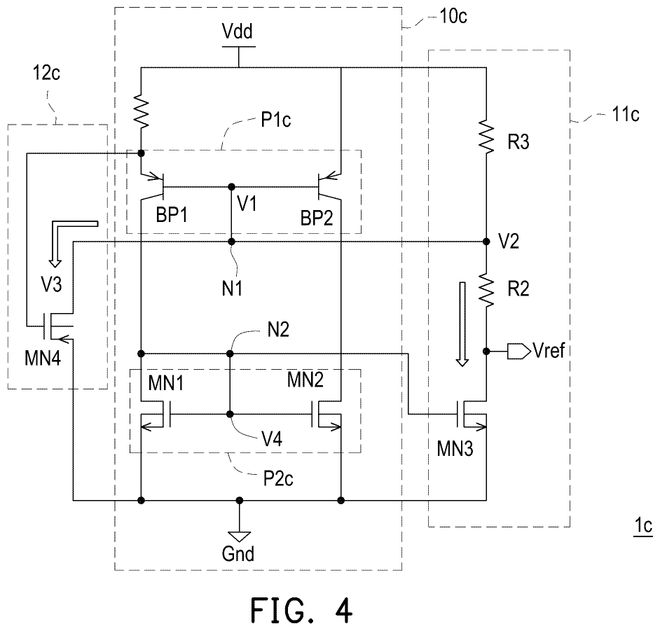

FIG. 4 is a circuit schematic diagram of a bandgap circuit 1c. The bandgap circuit 1c of FIG. 4 is similar to the bandgap circuit 1a of FIG. 2. The difference between the two is that in the bandgap circuit 1c of FIG. 4, all transistors are replaced with transistors with opposite conduction types.

A first transistor MN1 and a second transistor MN2 of a second transistor pair P2c are n-type metal oxide semi-transistors, and a first conduction type thereof may be, for example, a high voltage conduction type. A third transistor BP1 and a fourth transistor BP2 of a first transistor pair P1c are p-type bipolar junction transistors, and a second conduction type thereof may be, for example, a current controlled low voltage conduction type. Therefore, a first voltage may be, for example, (Vdd−V_{EB forward barrier of BP2}), and a fourth voltage may be, for example, a critical voltage of the first transistor MN1 superimposed on a ground voltage Gnd. A sixth transistor MN4 included in the startup circuit 12c is coupled between a first node N1 and the ground voltage Gnd, and is coupled to a node between a first resistor R1 and an emitter of the third transistor BP1 by a control terminal of the sixth transistor MN4. An aspect ratio of the first transistor MN1 to the second transistor MN2 to a fifth transistor MN3 is 1:1:N, where N is a positive real number. An emitter area ratio of the third transistor BP1 to the fourth transistor BP2 is 1:1.

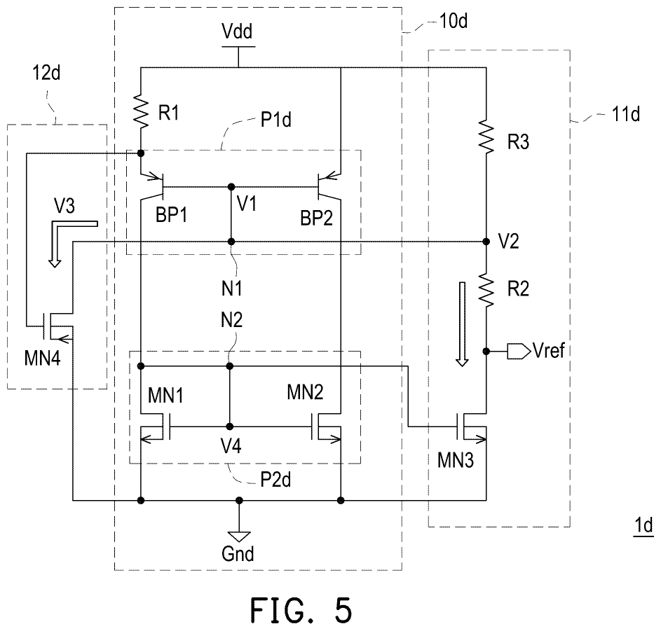

FIG. 5 is a circuit schematic diagram of a bandgap circuit 1d. The bandgap circuit 1d of FIG. 5 is similar to the bandgap circuit 1c of FIG. 4. The difference between the two is that in the bandgap circuit 1d of FIG. 5, an emitter area ratio of a third transistor BP1 to a fourth transistor BP2 of a first transistor pair P1d is 1:1.

Specifically, a first transistor MN1 and a second transistor MN2 of a second transistor pair P2d are n-type metal oxide semi-transistors, and a first conduction type thereof may be, for example, a high voltage conduction type. A third transistor BP1 and a fourth transistor BP2 of a first transistor pair P1d are p-type bipolar junction transistors, and a second conduction type thereof may be, for example, a low voltage conduction type. Therefore, a fourth voltage may be, for example, a critical voltage of the first transistor MN1 superimposed on a ground voltage. An aspect ratio of the first transistor MN1 to the second transistor MN2 to a fifth transistor MN3 is 1:1:N, where N is a positive real number. On the other hand, an emitter area ratio of the third transistor BP1 to the fourth transistor BP2 is 1:1.

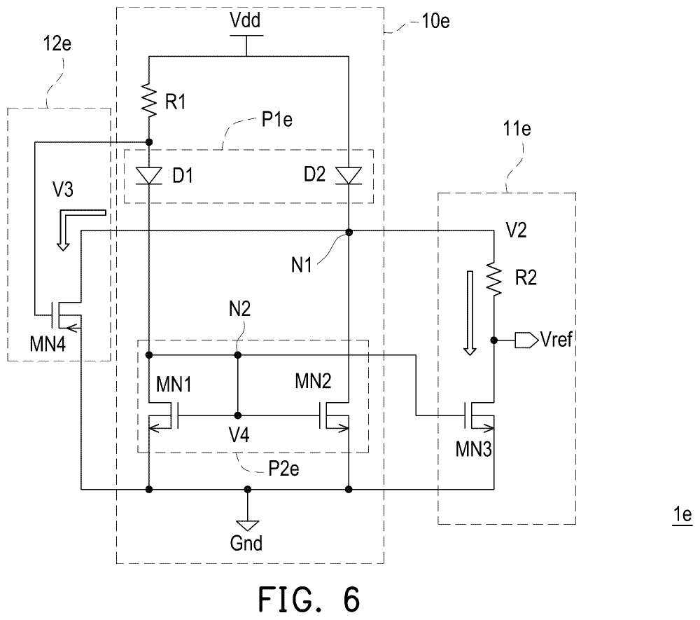

FIG. 6 is a circuit schematic diagram of a bandgap circuit 1e, transistors in a first transistor pair P1e in a current mirror circuit 10e are replaced by a pair of diodes D1 and D2, and a resistor R3 in a compensation circuit 11e is removed.

In the current mirror circuit 10e, the first transistor pair P1e includes the diodes D1 and D2. An anode of the diode D1 is coupled to a resistor R1 and is coupled to a working voltage Vdd through the resistor R1, and a cathode of the diode D1 is coupled to a first transistor MN1. To form a self-biased self-initiating path of a diode connection, the magnitude of a first voltage difference ΔV1 with a positive temperature coefficient of the resistor R1 is determined by a residual voltage difference after subtracting a forward barrier voltage of the diode D1 (V_{forward barrier of diode}) and a gate-source voltage of the first transistor MN1 from the working voltage Vdd, and a fifth current with a positive temperature coefficient flowing through the resistor R1 is generated. An anode of the diode D2 is directly coupled to the working voltage Vdd, and a cathode of the diode D2 is coupled to a first node N1 of a second transistor MN2. The first transistor MN1 and the second transistor MN2 form a current mirror, a drain current of the two is equally proportional to an aspect ratio of the first transistor MN1 to the second transistor MN2, and temperature coefficients of currents of the two are the same due to being controlled by the forward barrier voltages of the diodes.

Furthermore, a fifth transistor MN3 and a resistor R2 in the compensation circuit 11e are connected in series between the first node N1 and a ground voltage Gnd, and a fourth voltage V4 of a second node N2 is received by a control terminal of the third transistor MN3. In this way, the compensation circuit 11e may generate a first current I1 and a second voltage difference ΔV2 with positive temperature coefficients in proportion to a current I5 with a positive temperature coefficient according to the fourth voltage V4 of the second node N2 and an aspect ratio of the first transistor MN1 to the third transistor MN3 to be provided to the first node N1 of the current mirror circuit 10e.

A fourth transistor MN4 included in a pre-startup and additional current source circuit 12e is coupled between the first node N1 and the ground voltage Gnd by the second resistor R2 and is coupled to a node between the resistor R1 and the diode D1 by a control terminal of the fourth transistor MN4. The voltage at the node is a self-adjusting bias voltage V5, that is, the circuit uses negative feedback to input the self-adjusting bias voltage to generate an additional current with a monotonic self-adjustable negative temperature coefficient or a non-monotonic self-adjustable temperature coefficient. In this way, the startup circuit 12e may quickly provide the first voltage to the first node N1 during a pre-startup phase of the bandgap circuit 1e, and obtain an initial V_{ref} (for example, V_{dd}−V_{forward barrier of diode}−I₂*R2). After the self-bias startup of the diode connection is completed, the V_{ref} stabilizes (for example, V_{dd}−V_{forward barrier of diode}−I₂*R2−I₁*R2) to shorten the startup time of the bandgap circuit 1e.

The first transistor MN1 and the second transistor MN2 of a second transistor pair P2e are n-type metal oxide semi-transistors, and a first conduction type thereof may be, for example, a high voltage conduction type, the first voltage may be, for example, Vdd−V_{forward barrier of diode}, and the fourth voltage may be, for example, a fourth voltage level formed by a critical voltage of the N-type first transistor MN1, that is, the fourth voltage is the critical voltage of the first transistor MN1 superimposed on the ground voltage Gnd. An aspect ratio of the first transistor MN1 to the second transistor MN2 to a fifth transistor MN3 is 1:1:N, where N is a positive real number. On the other hand, a junction area ratio of the diode D1 to the diode D2 is M:1, such as 8:1.

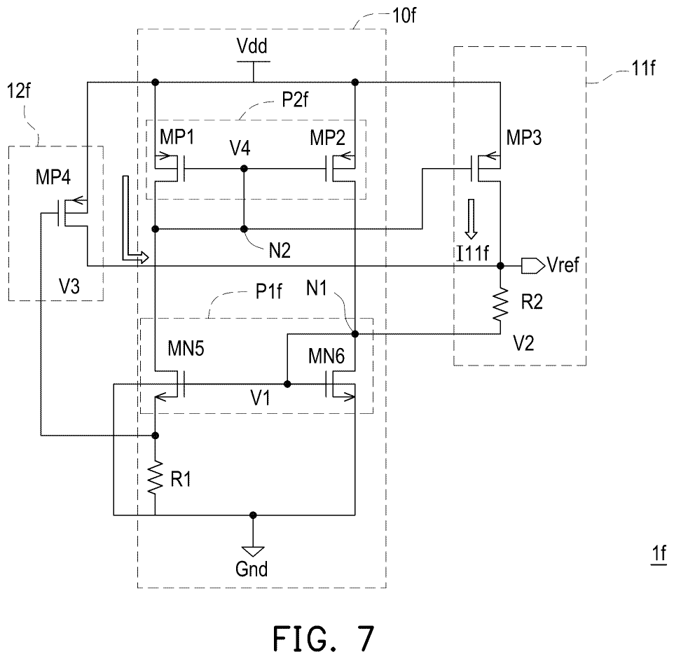

FIG. 7 is a circuit schematic diagram of a bandgap circuit 1f. The bandgap circuit 1f includes a current mirror circuit 10f, a compensation circuit 11f, and a startup circuit 12f. The current mirror circuit 10f has a first transistor pair P1f with control terminals coupled to each other at a first node N1. The first transistor pair P1f is configured to generate a first voltage V1 with a negative temperature coefficient at the first node N1. The compensation circuit 11f is used to generate a second voltage difference ΔV2 with a positive temperature coefficient, and provide the second voltage difference ΔV2 to the first node N1. The startup circuit 12f is used to provide a second current I2 with a self-adjustable temperature coefficient to the first node N1 when the bandgap circuit 1f is initiated, so as to provide a first voltage (for example, a first voltage level formed by a critical voltage of a fourth transistor MN6, that is, the first voltage is the critical voltage of the fourth transistor MN6 superimposed on a ground voltage Gnd) to the first node N1 through a resistor R2.

The current mirror circuit 10f is, for example, a current mirror circuit with a Widlar current source. The current mirror circuit 10f includes a first transistor pair P1f, a second transistor pair P2f, and a resistor R1. The first transistor pair P1f includes transistors MN5 and MN6 with control terminals coupled to each other at the first node N1. The second transistor pair P2f includes transistors MP1 and MP2 with control terminals coupled to each other at a second node N2. The second transistor pair P2f is configured to generate a current dependent on the first transistor pair P1f with a current mirror structure, and generate a fourth voltage V4 with a positive temperature coefficient at the second node N2.

The second transistor pair P2f includes transistors MP1 and MP2. The first transistor MP1 has a first terminal receiving a working voltage, a second terminal coupled to the second node N2, and a control terminal coupled to the second node N2. The second transistor MP2 has a first terminal receiving the working voltage, a control terminal coupled to the second node N2, and a second terminal. The first transistor pair P1f includes a third transistor MN5 and a fourth transistor MN6. The third transistor MN5 has a first terminal coupled to the second terminal of the first transistor MP1, a second terminal coupled to the resistor R1, and a control terminal coupled to the first node N1, wherein the resistor R1 is coupled between the third transistor MN5 and the ground voltage Gnd. The fourth transistor MN6 has a first terminal coupled to the second terminal of the second transistor MP2 and the first node N1, a second terminal receiving the ground voltage Gnd, and a control terminal coupled to the first node N1.

The compensation circuit 11f is coupled to the second transistor pair P2f at the second node N2. The compensation circuit 11f is configured to generate a second voltage V2 according to the fourth voltage V4, and provide the second voltage difference ΔV2 to the first node N1, the compensation circuit 11f includes a fifth transistor MP3 and the resistor R2. The fifth transistor MP3 has a first terminal receiving a working voltage Vdd, a control terminal coupled to the second node N2, and a second terminal. The resistor R2 has a first terminal coupled to the second terminal of the fifth transistor MP3 and a second terminal coupled to the first node N1. Therefore, the compensation circuit 11f generates the second voltage difference ΔV2 through the resistor R2 to be provided to the first node N1.

The startup circuit 12f is used to provide a first voltage and a startup current (also an additional current with a first self-adjustable temperature coefficient in the disclosure) when the bandgap circuit 1f is initiated, and provide the first voltage (for example, a first voltage level formed by a critical voltage of the N-type fourth transistor MN6, that is, the first voltage is the critical voltage of the fourth transistor MN6 superimposed on the ground voltage Gnd) to the first node N1 through the second resistor R2. The startup circuit 12f includes a sixth transistor MP4. The sixth transistor has a first terminal receiving the working voltage Vdd, a second terminal coupled to the second terminal of the fifth transistor MP3, and a control terminal coupled to the second terminal of the third transistor MN5. Therefore, specifically, the startup circuit 12f provides the first voltage to the first node N1 through the resistor R2 when initiated.

The first transistor MP1 and the second transistor MP2 of the second transistor pair P2f are p-type metal oxide semi-transistors and have a first conduction type (for example, a low voltage conduction type). The third transistor MN5 and the fourth transistor MN6 of the first transistor pair P1f are n-type metal oxide semi-transistors and have a second conduction type (for example, a high voltage conduction type). An aspect ratio of the first transistor MP1 to the second transistor MP2 to the fifth transistor MP3 is 1:1:N, where N is a positive real number. On the other hand, an aspect ratio of the third transistor MN5 to the fourth transistor MN6 is 1:1.

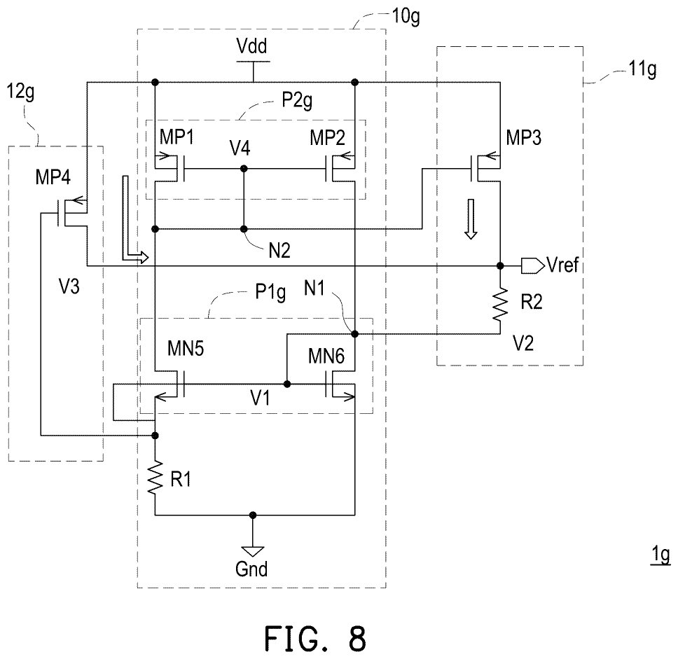

FIG. 8 is a circuit schematic diagram of a bandgap circuit 1g. The bandgap circuit 1g of FIG. 8 is similar to the bandgap circuit 1f of FIG. 7. The only difference between the two is that a base of a third transistor MN5 in the bandgap circuit 1g is coupled to a second terminal of the third transistor MN5.

A first transistor MP1 and a second transistor MP2 of a second transistor pair P2g are p-type metal oxide semi-transistors and have a first conduction type. A third transistor MN5 and a fourth transistor MN6 of a first transistor pair P1g are n-type metal oxide semi-transistors and have a second conduction type. An aspect ratio of the first transistor MP1 to the second transistor MP2 to a fifth transistor MP3 is 1:1:N, where N is a positive real number. On the other hand, an aspect ratio of the third transistor MN5 to the fourth transistor MN6 is 1:1.

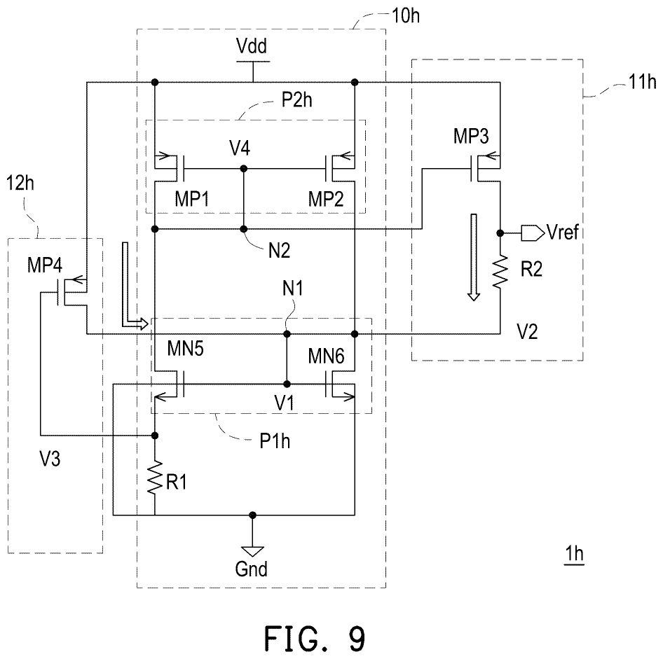

FIG. 9 is a circuit schematic diagram of a bandgap circuit 1h. The bandgap circuit 1h of FIG. 9 is similar to the bandgap circuit 1f of FIG. 7. The only difference between the two is that in the bandgap circuit 1h of FIG. 9, a second terminal of a sixth transistor MP4 in a startup circuit 12h is changed from being coupled to a second terminal of a fifth transistor MP3 to being coupled to a first node N1.

A first transistor MP1 and a second transistor MP2 of a second transistor pair P2h are p-type metal oxide semi-transistors and have a first conduction type. A third transistor MN5 and a fourth transistor MN6 of a first transistor pair P1h are n-type metal oxide semi-transistors and have a second conduction type. An aspect ratio of the first transistor MP1 to the second transistor MP2 to a fifth transistor MP3 is 1:1:N, where N is a positive real number. On the other hand, an aspect ratio of the third transistor MN5 to the fourth transistor MN6 is 1:1.

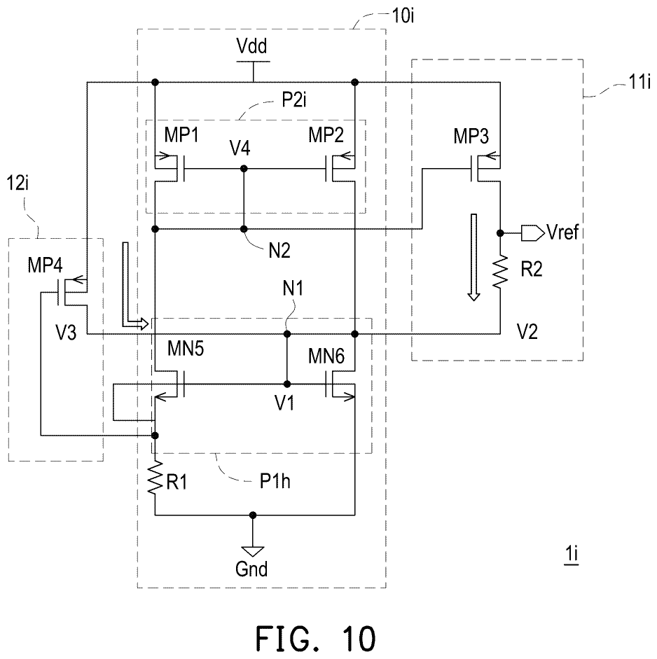

FIG. 10 is a circuit schematic diagram of a bandgap circuit 1i. The bandgap circuit 1i of FIG. 10 is similar to the bandgap circuit 1h of FIG. 9. The only difference between the two is that in the bandgap circuit 1i of FIG. 10, a base of a third transistor MN5 is changed from being coupled to a ground voltage Gnd to being coupled to a second terminal of the third transistor MN5.

A first transistor MP1 and a second transistor MP2 of a second transistor pair P2i are p-type metal oxide semi-transistors and have a first conduction type. A third transistor MN5 and a fourth transistor MN6 of a first transistor pair P1i are n-type metal oxide semi-transistors and have a second conduction type. An aspect ratio of the first transistor MP1 to the second transistor MP2 to a fifth transistor MP3 is 1:1:N, where N is a positive real number. On the other hand, an aspect ratio of the third transistor MN5 to the fourth transistor MN6 is 1:1.

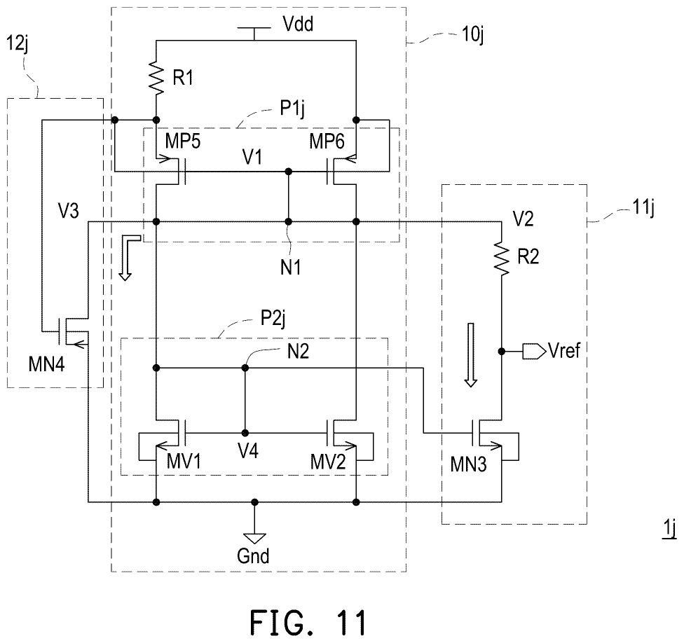

FIG. 11 is a circuit schematic diagram of a bandgap circuit 1j. The bandgap circuit 1j of FIG. 11 is similar to the bandgap circuit 1i of FIG. 10. The difference between the two is that in the bandgap circuit 1j of FIG. 11, all transistors are replaced with transistors with opposite conduction types.

A first transistor MN1 and a second transistor MN2 of a second transistor pair P2j are n-type metal oxide semi-transistors, and a first conduction type thereof may be, for example, a high voltage conduction type. A third transistor MP5 and a fourth transistor MP6 of a first transistor pair P1j are p-type metal oxide semi-transistors, and a second conduction type thereof may be, for example, a low voltage conduction type. Therefore, a first voltage may be, for example, a first voltage level formed by a critical voltage of the p-type fourth transistor MP6, that is, the first voltage is a working voltage Vdd minus the critical voltage of the fourth transistor MP6, and a fourth voltage may be, for example, a fourth voltage level formed by a critical voltage of the n-type first transistor MN1, that is, the fourth voltage is a ground voltage Gnd superimposed on the critical voltage of the first transistor MN1. An aspect ratio of the first transistor MN1 to the second transistor MN2 to a fifth transistor MN3 is 1:1:N, where N is a positive real number. On the other hand, an aspect ratio of the third transistor MP1 to the fourth transistor MP2 is 1:1.

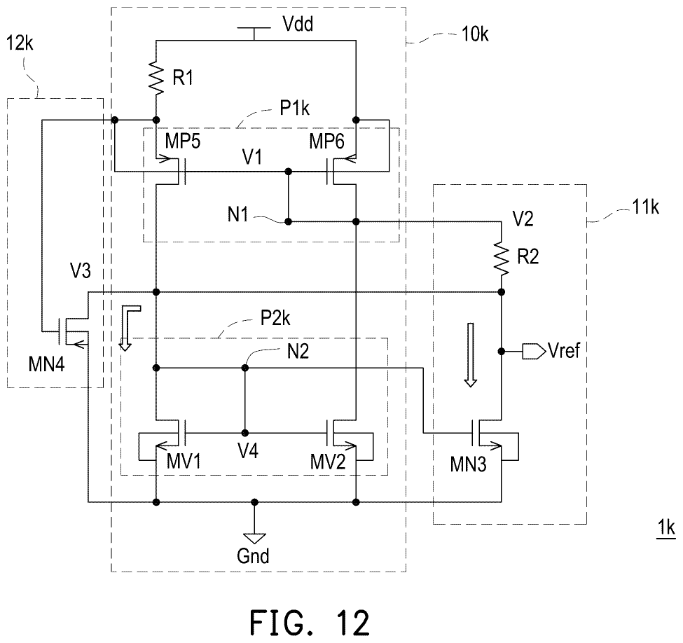

FIG. 12 is a circuit schematic diagram of a bandgap circuit 1k. The bandgap circuit 1k of FIG. 12 is similar to the bandgap circuit 1j of FIG. 11. The only difference between the two is that in the bandgap circuit 1k of FIG. 12, a drain of a sixth transistor MN4 in a startup circuit 12k is changed from being coupled to a first node N1 to being coupled to a drain of a fifth transistor MN3.

A first transistor MN1 and a second transistor MN2 of a second transistor pair P2k are n-type metal oxide semi-transistors, and a first conduction type thereof may be, for example, a high voltage conduction type. A third transistor MP5 and a fourth transistor MP6 of a first transistor pair P1k are p-type metal oxide semi-transistors, and a second conduction type thereof may be, for example, a low voltage conduction type. Therefore, an aspect ratio of the first transistor MN1 to the second transistor MN2 to a fifth transistor MN3 is 1:1:N, where N is a positive real number. On the other hand, an aspect ratio of the third transistor BP1 to the fourth transistor BP2 is 1:1.

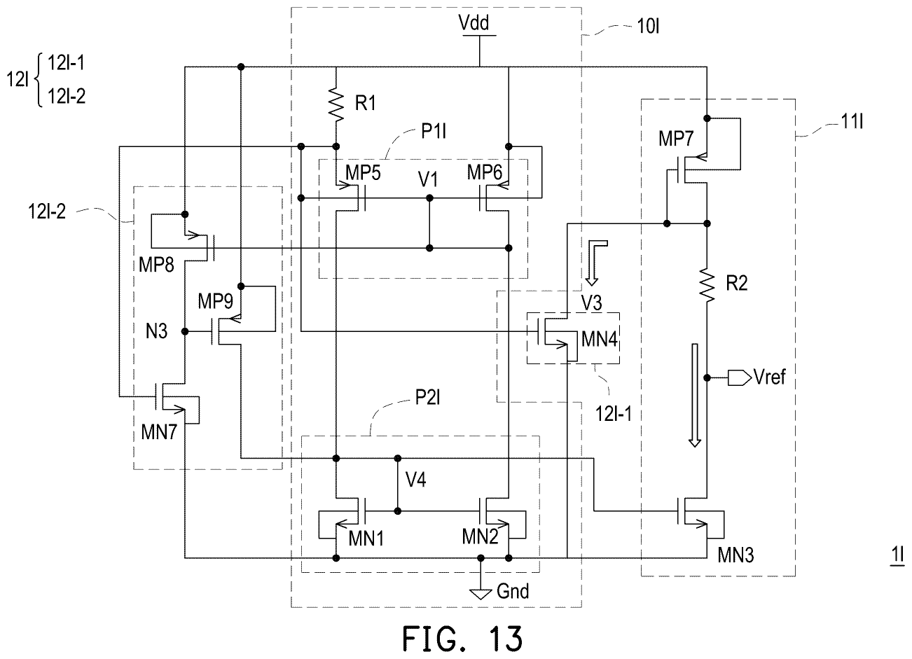

FIG. 13 is a circuit schematic diagram of a bandgap circuit 1l. The bandgap circuit 1l of FIG. 13 is similar to the bandgap circuit 1k of FIG. 12. The difference between the two is that in the bandgap circuit 1l of FIG. 13, a compensation circuit 11l and a startup circuit 12l respectively replace a compensation circuit 11k and the startup circuit 12k in the bandgap circuit 1k of FIG. 12.

The compensation circuit 11l includes a fifth transistor MN3, a resistor R2, and a seventh transistor MP7. The seventh transistor MP7, the resistor R2, and the fifth transistor MN3 are sequentially connected in series between a working voltage Vdd and a ground voltage Gnd. Specifically, the seventh transistor MP7 has a source receiving the working voltage Vdd, a drain, and a gate. The resistor R2 has a first terminal and a second terminal coupled to the drain and the gate of the seventh transistor MP7. The fifth transistor MN3 has a drain coupled to the second terminal of the resistor R2, a source receiving the ground voltage Gnd, and a gate coupled to a second node N2.

The startup circuit 12l includes a first startup circuit 12l-1 and a second startup circuit 12l-2. The first startup circuit 12l-1 is coupled to the drain of the seventh transistor MP7 in the compensation circuit 11l. The first startup circuit 12l-1 is configured to selectively provide the ground voltage Gnd to a node between the drain of the seventh transistor MP7 and the resistor R2 according to a source voltage of the third transistor MP5. The first startup circuit 12l-1 has a sixth transistor MN6, which has a drain coupled to the drain of the seventh transistor MP7, a source receiving the ground voltage Gnd, and a gate coupled to the source of the third transistor MP5.

The second startup circuit 12l-2 is configured to provide the fourth voltage (which may be, for example, a fourth voltage level formed by the critical voltage of the n-type first transistor MN1) to the drain of the first transistor MN1 in the bandgap circuit 1l. The fourth voltage is the ground voltage Gnd superimposed on the critical voltage and the startup current of the first transistor MN1. The second startup circuit 12l-2 includes an eighth transistor MP8, a ninth transistor MP9, and a tenth transistor MN7. The eighth transistor MP8 has a source receiving the working voltage Vdd, a drain coupled to a third node N3, and a gate coupled to a first node N1. The ninth transistor MP9 has a source receiving the working voltage Vdd, a drain coupled to the second node N2, and a gate coupled to the third node N3. The tenth transistor MN7 has a drain coupled to the third node N3, a source receiving the ground voltage Gnd, and a gate coupled to the source of the third transistor MP5.

Specifically, when the bandgap circuit 1l is initiated, when each transistor has not yet entered the working state, in the first startup circuit 12l-1, the source voltage of the third transistor MP5 is at a voltage level close to the working voltage Vdd, thus controlling a sixth transistor MN4 to be conducted to provide the ground voltage Vdd−V_{TH of MP7} to the drain and the gate of the seventh transistor MP7.

In addition, for the operation of the second startup circuit 12l-2, when the bandgap circuit 1l is initiated, the tenth transistor MN7 provides the ground voltage Gnd to the third node N3, thereby controlling the ninth transistor MP9 to be conducted. In this way, the ninth transistor MP9 may provide a V_{GND}+V_{TH of MN1} voltage, that is, the fourth voltage, to the second node N2. Further, as the third transistor MP5 and the fourth transistor MP6 enter the appropriate working state, the source and a gate voltage and a driving current of the third transistor MP5 increase and are gradually pulled down. In this way, the eighth transistor MP8 is gradually conducted, so that the voltage at the node N3 increases, causing the ninth transistor MNP9 to be gradually disconnected, thereby controlling the ninth transistor MP9 to be an open circuit. In short, when the bandgap circuit 1l is initiated, the second startup circuit 12l-2 may provide the V_{GND}+V_{TH of MN1} voltage to the second node N2, and stop providing the startup current to the second node N2 in a timely manner after the bandgap circuit 1l enters the appropriate working state to prevent further affecting subsequent operations of the bandgap circuit 1l.

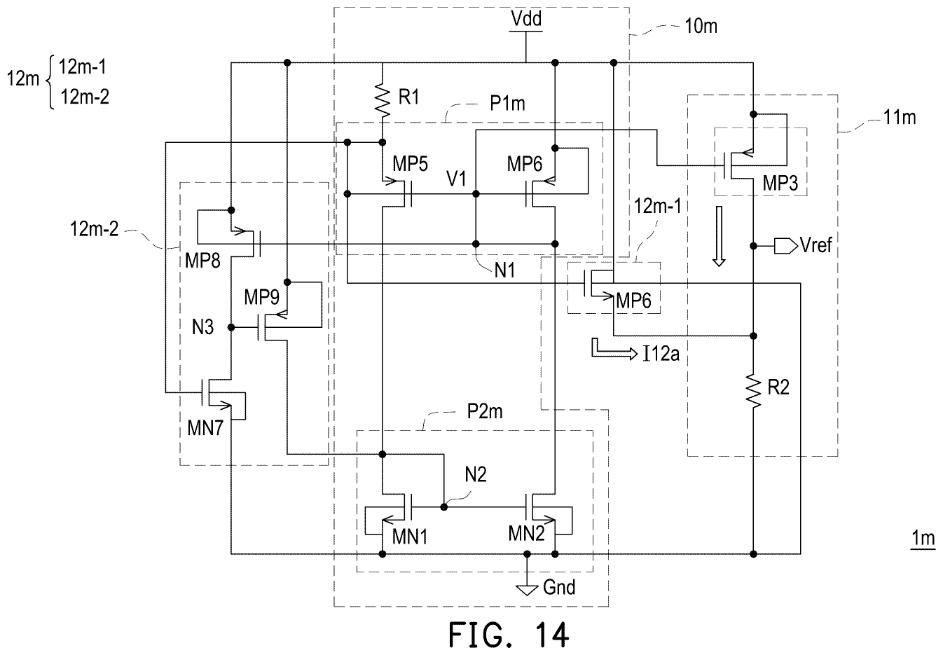

FIG. 14 is a circuit schematic diagram of a bandgap circuit 1m. The bandgap circuit 1m of FIG. 14 is similar to the bandgap circuit 1l of FIG. 13. The difference between the two is that in the bandgap circuit 1m of FIG. 14, a compensation circuit 11m and a startup circuit 12m respectively replace the compensation circuit 11l and the startup circuit 12l in the bandgap circuit 1l of FIG. 13.

The compensation circuit 11m includes a fifth transistor MP3 and a resistor R2. The fifth transistor MP3 has a source receiving a working voltage Vdd, a gate coupled to a first node N1, and a drain. A first terminal and a second terminal of the resistor R2 are respectively coupled to the drain of the fifth transistor MP3 and a ground voltage Gnd. Accordingly, the compensation circuit 11m generates a current I11m with a positive temperature coefficient according to a first voltage V1 at the first node N1.

The startup circuit 12m includes a first startup circuit 12m-1 and a second startup circuit 12m-2. The first startup circuit 12m-1 is coupled to a node between the fifth transistor MP3 and the resistor R2 in the compensation circuit 11m. The first startup circuit 12m-1 is configured to selectively provide a current with a negative temperature coefficient to the node between the fifth transistor MP3 and the resistor R2 according to a source voltage of the third transistor MP5 and generate a voltage difference with a negative temperature coefficient on the resistor R2. The first startup circuit 12m-1 has a sixth transistor MN6, which has a drain receiving the working voltage Vdd, a source coupled to the resistor R2, and a gate coupled to the source of the third transistor MP5.

The second startup circuit 12m-2 is configured to provide a V_{GND}+V_{TH of MN1} voltage, that is, a fourth voltage, to the drain of the first transistor MN1 in the bandgap circuit 1m. The second startup circuit 12m-2 includes an eighth transistor MP8, a ninth transistor MP9, and a tenth transistor MN7. The eighth transistor MP8 has a source receiving the working voltage Vdd, a drain coupled to a third node N3, and a gate coupled to the first node N1. The ninth transistor MP9 has a source receiving the working voltage Vdd, a drain coupled to a second node N2, and a gate coupled to the third node N3. The tenth transistor MN7 has a drain coupled to the third node N3, a source receiving the ground voltage Gnd, and a gate coupled to the source of the third transistor MP5.

Specifically, when the bandgap circuit 1m is initiated, when each transistor has not yet entered the working state, in the first startup circuit 12m-1, the source voltage of the third transistor MP5 is at a voltage level close to the working voltage Vdd, thus controlling the sixth transistor MN6 to be conducted to provide the current with the negative temperature coefficient to a node between the drain of the fifth transistor MP3 and the resistor R2 and generate the voltage difference with the negative temperature coefficient on the resistor R2. On the other hand, the first startup circuit 12m-1 may generate a current I12m with a negative temperature coefficient. In this way, the current I11m with the positive temperature coefficient generated by the compensation circuit 11m may be summed with the current I12m with the negative temperature coefficient generated by the first startup circuit 12m-1, so that a compensated reference voltage Vref is generated at the node between the drain of the fifth transistor MP3 and the resistor R2.

In addition, for the operation of the second startup circuit 12m-2, when the bandgap circuit 1m is connected to the working voltage Vdd, the tenth transistor MN7 provides the ground voltage Gnd to the third node N3, thereby controlling the ninth transistor MP9 to be conducted. In this way, the ninth transistor MP9 may provide the V_{GND}+V_{TH of MN1} voltage, that is, the fourth voltage, to the second node N2. Further, as the third transistor MP5 and the fourth transistor MP6 enter the appropriate working state, the source and a gate voltage and a driving current of the third transistor MP5 increase and are gradually pulled down. As a result, the eighth transistor MP8 is gradually conducted, so that the voltage at the node N3 increases, causing the ninth transistor MP9 to be gradually disconnected, thereby controlling the ninth transistor MP9 to be an open circuit. In short, when the bandgap circuit 1m is initiated, the second startup circuit 12m-2 may provide the V_{GND}+V_{TH of MN1} voltage, that is, the fourth voltage, to the second node N2, and stop providing the startup current to the second node N2 in a timely manner after the bandgap circuit 1m enters the appropriate working state to prevent further affecting subsequent operations of the bandgap circuit 1m.

In summary, the bandgap circuit of the disclosure has the compensation circuit and the startup circuit, which can reduce the startup time of the bandgap circuit while compensating for temperature. Moreover, the startup circuit may also be used to fine-tune the compensation circuit at the same time, thus effectively shortening the startup time of the bandgap circuit and maintaining the stability of the output voltage of the bandgap circuit, and the overall bandgap circuit becomes an extremely simple circuit and a circuit with the characteristic of homogeneous element composition due to having the minimalistic startup circuit.

What is claimed is:

1. A bandgap circuit, comprising:
a current mirror circuit, having a first transistor pair with control terminals coupled to each other at a first node, wherein the first transistor pair is configured to generate a first voltage with a negative temperature coefficient at the first node;
a compensation circuit, used to generate a second voltage with a positive temperature coefficient to the first node; and
a startup circuit, used to initiate the bandgap circuit and provide a first voltage to the first node.

2. The bandgap circuit according to claim 1, wherein the current mirror circuit comprises a second transistor pair with control terminals coupled to each other at a second node and coupled to the first transistor pair, the second transistor pair is configured to receive a current provided by the first transistor pair, and generate a fourth voltage with a positive temperature coefficient at the second node.

3. The bandgap circuit according to claim 2, wherein the second transistor pair comprises:
a first transistor, having a first terminal receiving the first voltage, a second terminal coupled to the second node, and a control terminal coupled to the second node; and
a second transistor, having a first terminal receiving the first voltage, a control terminal coupled to the second node, and a second terminal.

4. The bandgap circuit according to claim 2, comprising a first resistor, wherein the first transistor pair comprises:
a third transistor, having a first terminal coupled to a second terminal of a first transistor, a second terminal coupled to the first resistor, and a control terminal coupled to the first node, wherein the first resistor is coupled between the third transistor and a second voltage; and
a fourth transistor, having a first terminal coupled to a second terminal of a second transistor, a second terminal receiving a ground voltage, and a control terminal coupled to the first node.

5. The bandgap circuit according to claim 4, wherein the first transistor and the second transistor have a first conduction type, and the third transistor and the fourth transistor have a second conduction type,
wherein when the first conduction type is a low voltage conduction type and the second conduction type is a high voltage conduction type, the first voltage is a working voltage and the second voltage is a ground voltage,
wherein when the first conduction type is the high voltage conduction type and the second conduction type is the low voltage conduction type, the first voltage is the ground voltage and the second voltage is the working voltage.

6. The bandgap circuit according to claim 2, wherein the compensation circuit is coupled to the second transistor pair at the second node, the compensation circuit is configured to generate the second voltage according to the fourth voltage, and provide the second voltage to the first node.

7. The bandgap circuit according to claim 4, wherein the third transistor and the fourth transistor are bipolar junction transistors, and the compensation circuit comprises:
a fifth transistor, having a first terminal receiving the working voltage, a control terminal coupled to the second node, and a second terminal;
a second resistor, having a first terminal coupled to the second terminal of the fifth transistor, and a second terminal coupled to the first node; and
a third resistor, having a first terminal coupled to the first node and a second terminal receiving the ground voltage.

8. The bandgap circuit according to claim 7, wherein the startup circuit comprises:
a sixth transistor having a first terminal receiving the first voltage, a second terminal coupled to the first node, and a control terminal coupled to the second terminal of the third transistor.

9. The bandgap circuit according to claim 4, wherein the third transistor and the fourth transistor are metal oxide transistors, the first terminal and the control terminal of the fourth transistor are coupled to the first node, and the compensation circuit comprises:
a fifth transistor, having a first terminal receiving the working voltage, a control terminal coupled to the second node, and a second terminal; and
a second resistor, having a first terminal coupled to the second terminal of the fifth transistor and a second terminal coupled to the first node.

10. The bandgap circuit according to claim 5, wherein the startup circuit comprises:
a sixth transistor, having a first terminal receiving the working voltage, a second terminal coupled to a first terminal of a second resistor, and a second terminal coupled to the second terminal of the third transistor.

11. The bandgap circuit according to claim 1, wherein the first terminals of the first transistor pair respectively receive the same amount of currents.

12. A bandgap circuit, comprising:
a current mirror circuit, having a diode pair, wherein the diode pair is configured to generate a first voltage with a negative temperature coefficient at a first node;
a compensation circuit, used to generate a second voltage difference with a positive temperature coefficient to the first node; and
a startup circuit, used to provide a first voltage to the first node when the bandgap circuit is initiated.

13. A bandgap circuit, comprising:
a Widlar current mirror circuit, configured to generate a first voltage with a positive temperature coefficient, wherein the Widlar current mirror circuit generates a second voltage with a negative temperature coefficient by a first node coupled between a first resistor and a first transistor;
a compensation circuit, used to generate a first current according to the first voltage; and
a startup circuit, used to provide a first voltage to the compensation circuit to initiate the compensation circuit when the bandgap circuit is initiated.

14. The bandgap circuit according to claim 13, wherein a first terminal of the first resistor receives the first voltage, a second terminal of the first resistor is coupled to the first transistor, the Widlar current mirror circuit comprises:
a first transistor pair, comprising:
the first transistor having a first terminal coupled to the first resistor, a control terminal and a second terminal; and
a second transistor having a first terminal receiving the first voltage, a control terminal coupled to the control terminal of the first transistor, and a second terminal coupled to the control terminal of the first transistor; and
a second transistor pair, comprising:
a third transistor having a first terminal coupled to the second terminal of the first transistor, a control terminal coupled to the first terminal of the third transistor, and a second terminal receiving a second voltage; and
a fourth transistor having a first terminal coupled to the second terminal of the second transistor, a control terminal coupled to the control terminal of the third transistor, and a second terminal receiving the second voltage.

15. The bandgap circuit according to claim 14, wherein the current mirror circuit provides the first voltage to the compensation from a node at which the control terminals of the third transistor and the fourth transistor are coupled to each other.

16. The bandgap circuit according to claim 14, wherein the compensation circuit receives the second voltage from the control terminals of the second transistor pair,
the compensation circuit comprises:
a fifth transistor having a first terminal receiving the first voltage, a control terminal, and a second terminal coupled to the control terminal of the fifth transistor;
a second resistor having a first terminal coupled to the second terminal of the fifth transistor, and a second terminal; and
a sixth transistor having a first terminal coupled to the second terminal of the second resistor, a control terminal coupled to the control terminals of the second transistor pair, and a second terminal receiving the second voltage,
the startup circuit comprises a first startup circuit, the first startup circuit comprising:
a seventh transistor having a first terminal coupled to the second terminal of the fifth transistor, a second terminal receiving the second voltage, and a control terminal coupled to the first terminal of the first transistor.

17. The bandgap circuit according to claim 14, wherein the compensation circuit receives the second control voltage from the control terminals of the first transistor pair,
wherein the compensation circuit comprises:
a fifth transistor having a first terminal for receiving the first voltage, a control terminal receiving the second control voltage, and a second terminal; and
a second resistor having a first terminal coupled to the second terminal of the fifth transistor, and a second terminal receiving the second voltage,
the startup circuit comprises a first startup circuit, the first startup circuit comprising:
a sixth transistor having a first terminal receiving the first voltage, a second terminal coupled to the second terminal of the fifth transistor, and a control terminal coupled to the first terminal of the first transistor.

18. The bandgap circuit according to claim 14, wherein the startup circuit includes a second startup circuit comprising:
an eighth transistor having a first terminal receiving the first voltage, a control terminal coupled to the control terminals of the first transistor pair, and a second terminal;
a ninth transistor having a first terminal coupled to the second terminal of the eighth transistor, a second terminal receiving the second voltage, and a control terminal coupled to the first terminal of the first transistor; and
a tenth transistor having a first terminal receiving the first voltage, a second terminal coupled to the control terminals of the second transistor pair, and a control terminal coupled to the second terminal of the eighth transistor.

19. The bandgap circuit according to claim 18, wherein the second startup circuit is used to provide the first voltage to the control terminals of the second transistor pair when the band gap circuit is started.
